(19) United States
(12) Patent Application Publication
(10) Pub. No.: US 2023/0245429 A1
(43) Pub. Date: Aug. 3, 2023

(54) METHOD AND APPARATUS FOR TRAINING LANE LINE DETECTION MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Yue He, Beijing (CN); Yingying Li, Beijing (CN); Xiao Tan, Beijing (CN); Hao Sun, Beijing (CN)

(73) Assignee: BEIJING BAIDU NETCOM SCIENCE TECHNOLOGY CO., LTD., Beijing (CN)

(21) Appl. No.: 18/003,463

(22) PCT Filed: Jan. 29, 2022
(86) PCT No.: PCT/CN2022/075105

§ 371 Date: Dec. 27, 2022

(30) Foreign Application Priority Data
Apr. 28, 2021 (CN) 202110470476.1

(51) Int. Cl. G06V 10/774; G06V 20/56

(52) U.S. Cl. CPC G06V 10/774; G06V 20/588

(57) ABSTRACT

A method for training a lane line detection model includes: obtaining a plurality of road condition sample images and a plurality pieces of labeled lane line information corresponding to the plurality of road condition sample images; determining a plurality of elements corresponding to the plurality of road condition sample images and a plurality of element semantics corresponding to the plurality of elements; and obtaining the lane line detection model by training an initial artificial intelligence model based on the plurality of road condition sample images, the plurality of elements, the plurality of element semantics and the plurality pieces of labeled lane line information.

### CROSS-REFERENCE TO RELATED APPLICATIONS

This application is a U.S. national phase application of International Application No. PCT/CN2022/075105, filed on Jan. 29, 2022, which is based on and claims priority to Chinese Patent Application No. 202110470476.1, filed on Apr. 28, 2021, the entire contents of which are incorporated herein by their references.

### TECHNICAL FIELD

The disclosure relates to the technical field of artificial intelligence (AI), in particular to the technical fields of computer vision and deep learning, and can be applied to smart traffic scenes, in particular to a method for training a lane line detection model, an apparatus for training a lane line detection model, an electronic device and a storage medium.

### BACKGROUND

AI is a subject that studies the use of computers to simulate certain human thinking processes and intelligent behaviors (such as learning, reasoning, thinking and planning), which has both the hardware-level technology and the software-level technology. The AI hardware technology generally includes technologies such as sensor, special AI chip, cloud computing, distributed storage and big data processing. The AI software technology mainly includes computer vision, speech recognition technology, natural language processing technology and machine learning/deep learning, big data processing technology and knowledge map technology.

In the related art, semantic segmentation method logic for elements in road condition images cannot be directly applied to the detection and segmentation of lane lines. The computing complexity for detecting and segmenting lane lines is high and cannot meet real-time requirements.

### SUMMARY

According to a first aspect of the disclosure, a method for training a lane line detection model is provided. The method includes: obtaining a plurality of road condition sample images and a plurality pieces of labeled lane line information corresponding to the plurality of road condition sample images; determining a plurality of elements corresponding to the plurality of road condition sample images and a plurality of element semantics corresponding to the plurality of elements; and obtaining the lane line detection model by training an initial AI model based on the plurality of road condition sample images, the plurality of elements, the plurality of element semantics and the plurality pieces of labeled lane line information.

According to a second aspect of the disclosure, an electronic device is provided. The electronic device includes: at least one processor and a memory communicatively coupled to the at least one processor. The memory stores instructions executable by the at least one processor, and when the instructions are executed by the at least one processor, the method for training a lane line detection model according to the embodiments of the disclosure is implemented.

According to a third aspect of the disclosure, a non-transitory computer-readable storage medium having computer instructions stored thereon is provided. The computer instructions are configured to cause a computer to implement the method for training a lane line detection model according to the embodiments of the disclosure.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a schematic diagram of a first embodiment of the disclosure.

FIG. 2 is a schematic diagram of a second embodiment of the disclosure.

FIG. 3 is a schematic diagram of a third embodiment of the disclosure.

FIG. 4 is a schematic diagram of a fourth embodiment of the disclosure.

FIG. 5 is a block diagram of an electronic device for implementing a method for training a lane line detection model according to an embodiment of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

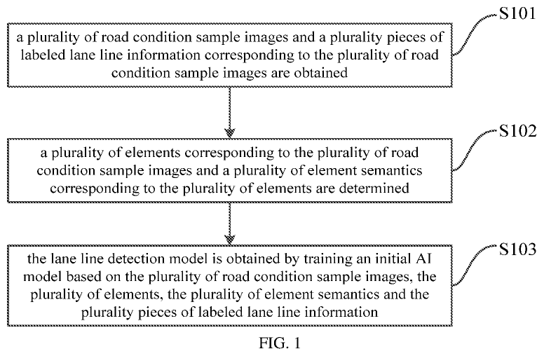

FIG. 1 is a schematic diagram of a first embodiment of the disclosure.

It should be noted that the executive body of the method for training a lane line detection model of the embodiment of the disclosure is an apparatus for training a lane line detection model, which can be realized by software and/or hardware. The apparatus can be configured in an electronic device, which includes but not limited to terminals and servers.

The embodiments of the disclosure relates to the technical field of AI, in particular to the technical fields of computer vision and deep learning, and can be applied to the smart traffic scenes, so that the computing complexity for detecting and recognizing lane lines in the road condition images is effectively reduced, the efficiency of detecting and recognizing lane lines is improved, and the effect of detecting and recognizing lane lines can be improved.

Artificial intelligence is abbreviated as AI, which is a new technical science that studies and develops the theories, methods, technologies and application systems used to simulate, extend and expand human intelligence.

Deep learning is to learn the internal law and representation level of sample data. The information obtained in the learning process is very helpful to the interpretation of data such as text, image and sound. The ultimate goal of deep learning is to enable machines to have the same analytical learning ability as people, and be able to recognize words, images, sounds and other data.

Computer vision refers to the use of cameras and computers instead of human eyes to identify, track and measure targets and other machine vision, and to further perform graphics processing, so that the images after computer processing can become images more suitable for human eyes to observe or for transmission to instruments for detection.

As illustrated in FIG. 1, a method for training a lane line detection model includes the following steps.

In S101, a plurality of road condition sample images and a plurality pieces of labeled lane line information corresponding to the plurality of road condition sample images are obtained.

The road condition images used to train the lane line detection model can be called the road condition sample images, and the road condition images can be the images captured by camera devices in the environment in the smart traffic scene, which is not limited.

In the embodiment of the disclosure, the plurality of road condition sample images can be obtained from a road condition sample image pool, and the plurality of road condition sample images can be used to train the initial AI model, to obtain a human attribute detection model.

After the plurality of road condition sample images and the plurality pieces of labeled lane line information corresponding to the plurality of road condition sample images are obtained, the plurality pieces of labeled lane line information can be used as labeled references when training the initial AI model.

The above lane line information can be used to describe the information related to the lane line in the road condition sample image, such as a lane line type, an image feature corresponding to the image area of the lane line, or determination on whether the lane line exists (also called a lane line state), or any other possible lane line information, which is not limited.

That is, in the embodiment of the disclosure, after the plurality of road condition sample images and the plurality pieces of labeled lane line information corresponding to the plurality of road condition sample images are obtained, the initial AI model can be trained according to the plurality of road condition sample images and the plurality pieces of labeled lane line information.

In S102, a plurality of elements corresponding to the plurality of road condition sample images and a plurality of element semantics corresponding to the plurality of elements are determined.

After the plurality of road condition sample images are obtained, an image recognition can be carried out on the plurality of road condition sample images, to obtain the elements corresponding to each road condition sample image and the element semantics corresponding to the elements. The elements can be, for example, sky, trees, and roads in the road condition sample image, and the element semantics can refer to an element type and an element feature of the sky, trees and roads. Generally, if the elements contains part of pixels in the image, the feature semantics can be obtained by classifying the elements based on the context information of the contained pixels, which is not limited.

After the plurality of elements corresponding to the plurality of road condition sample images and the plurality of element semantics corresponding to the plurality of elements are determined, the initial AI model can be trained based on the corresponding elements and element semantics in the road condition sample images and the plurality pieces of labeled lane line information, to obtain the lane line detection model.

That is, in the embodiment of the disclosure, when training the lane line detection model, an image analysis is carried out on the plurality of road condition sample images, to determine the plurality of elements corresponding to the plurality of road condition sample images and the plurality of element semantics corresponding to the plurality of elements. Then the initial AI model is trained based on the corresponding elements and element semantics in the road condition sample images and the plurality pieces of labeled lane line information, so as to realize a fusion and application of the semantic segmentation method logic of elements and the detection and recognition of lane lines. The processing logic based on element recognition can detect and recognize lane lines, so as to avoid relying on anchor box information of the lane lines in the road condition images, thereby reducing the complexity of model calculation and improving the efficiency of detection and recognition.

In S103, the lane line detection model is obtained by training an initial AI model based on the plurality of road condition sample images, the plurality of elements, the plurality of element semantics and the plurality pieces of labeled lane line information.

The initial AI model can be, for example, a neural network model, a machine learning model, or a graph neural network model. Certainly, any other possible model that can perform the task of image recognition and analysis can also be used, which is not limited.

After the road condition sample images, the elements, the element semantics and the plurality pieces of labeled lane line information are obtained, the road condition sample images, the elements and the element semantics can be input into the above neural network model, or a machine learning model or a graph neural network model respectively, so as to obtain the predicted lane line information output by any one of the above models. The predicted lane line information can be the lane line information predicted by any of the above models based on the model algorithm processing logic according to the elements and element semantics in the road condition sample images.

In some embodiments, when training the initial AI model, the road condition sample images, the elements and the element semantics can be input into the initial AI model, to obtain the plurality pieces of predicted lane line information output by the AI model. Then a convergence timing of the AI model can be determined based on the plurality pieces of predicted lane line information and the plurality pieces of labeled lane line information, that is, the trained AI model is determined as the lane line detection model, in response to a target loss value between the plurality pieces of predicted lane line information and the plurality pieces of labeled lane line information satisfying preset conditions. Therefore, the convergence timing of the model can be determined in time, and the trained lane detection model can effectively model the image features of lane lines in the smart traffic scene, which can effectively improve the efficiency of lane line detection and recognition of the lane line detection model, so that the trained lane line detection model can effectively meet the application scenarios with high real-time requirements.

There can be one or more target loss values, and the loss value between the predicted lane line information and the labeled lane line information can be called the target loss value.

In other embodiments, any other possible way can also be used to determine the convergence timing of the initial AI model and until the AI model satisfies certain convergence conditions, the trained AI model can be determined as the lane line detection model.

In the embodiment of the disclosure, after the plurality of road condition sample images and the plurality pieces of labeled lane line information corresponding to the plurality of road condition sample images are obtained, the plurality of elements corresponding to the plurality of road condition sample images, and the plurality of element semantics corresponding to the plurality of elements are determined. The lane line detection model is obtained by training the initial AI model based on the plurality of road condition sample images, the plurality of elements, the plurality of element semantics and the plurality pieces of labeled lane line information. In this way, the computing complexity for detecting and recognizing lane lines in the road condition images is effectively reduced, the efficiency of detecting and recognizing lane lines is improved, and the effect of detecting and recognizing lane lines can be improved.

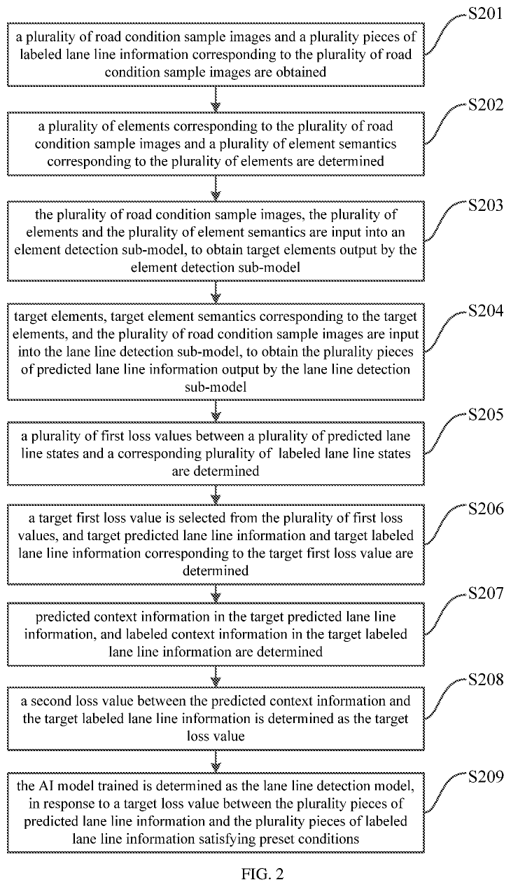

FIG. 2 is a schematic diagram of a second embodiment of the disclosure.

As illustrated in FIG. 2, a method for training a lane line detection model includes the following steps.

In S201, a plurality of road condition sample images and a plurality pieces of labeled lane line information corresponding to the plurality of road condition sample images are obtained.

In S202, a plurality of elements corresponding to the plurality of road condition sample images and a plurality of element semantics corresponding to the plurality of elements are determined.

The description of S201-S202 can refer to the above embodiment, and will not be repeated here.

In S203, the plurality of road condition sample images, the plurality of elements and the plurality of element semantics are input into an element detection sub-model, to obtain target elements output by the element detection sub-model.

In the embodiment of the disclosure, the initial AI model can include: an element detection sub-model and a lane line detection sub-model sequentially connected. Therefore, when the initial AI model is trained, the plurality of road condition sample images, the plurality of elements and the plurality of element semantics are input into the element detection sub-model, to obtain the target elements output by the element detection sub-model. The target elements can be used to assist the detection and recognition of lane lines.

The above element detection sub-model can be used for image feature extraction and can be regarded as a pre-trained model for a lane segmentation. The above obtained road condition sample images constitute a Cityscapes (city landscape) data set, and then the backbone network of the element detection sub-model can be trained for the feature extraction from each of the road condition sample images in the Cityscapes data set, to identify the elements and corresponding element semantics from each road condition sample image.

In detail, the above feature detection sub-model can be Deep High-Resolution Representation Learning for Visual Recognition Object Contextual Representation (HRNet-OCR) model, which is not limited in the disclosure. That is, the backbone network of the HRNet-OCR model can be used for the image feature extraction, and then, the structure of the HRNet-OCR model may be improved according to the embodiment of the disclosure and the improved HRNet-OCR model may be trained, to realize the fusion and application of semantic segmentation method logic of elements and detection and recognition of lane lines.

It can be understood that since the lane lines are usually labeled on the road surface, in the embodiment of the disclosure, the plurality of road condition sample images, the plurality of elements and the plurality of element semantics may be processed by the element detection sub-model, to output the target elements. The target elements can be elements with the element type of a road type. The target elements are identified, and then the target elements, the target element semantics corresponding to the target elements, and the plurality of road condition sample images are input into the lane line detection sub-model, to obtain the plurality pieces of predicted lane line information output by the lane line detection sub-model. Therefore, the pertinence of a model processing and recognition is improved, the interference from other elements on lane line detection can be avoided, and the accuracy of detection and recognition is improved while facilitating and improving the detection and recognition efficiency of the lane line detection model.

In S204, target elements, target element semantics corresponding to the target elements, and the plurality of road condition sample images are input into the lane line detection sub-model, to obtain the plurality pieces of predicted lane line information output by the lane line detection sub-model.

After the plurality of road condition sample images, the plurality of elements and the plurality of element semantics are processed by the element detection sub-model to output the target elements, the target elements, the target element semantics corresponding to the target elements, and the plurality of road condition sample images can be input into the lane line detection sub-model to obtain the plurality pieces of predicted lane line information output by the lane line detection sub-model.

The element semantics corresponding to the target elements can be called the target element semantics. When the target elements are elements with the element type of the road type, the target element semantics can be the road type and image features corresponding to the road.

The above predicted lane line information can specifically refer to the predicted lane line state and/or the predicted context information of multiple pixels in the image area covered by the lane line.

Correspondingly, the labeled lane line information can specifically refer to the labeled lane line state and/or the labeled context information of multiple pixels in the image area covered by the lane line.

That is, for each road condition sample image, there will be corresponding labeled lane line states and/or labeled context information. For each road condition sample image, there will be predicted lane line states and/or predicted context information output by the AI model.

The above lane line states may refer to a presence or an absence of lane lines, while the context information may be used to represent pixel features corresponding to each pixel in the image area covered by the lane lines, and the relative relation between each pixel and other pixels based on the image feature dimension (e.g., relative position relation, and relative depth relation), which is not limited.

In the embodiment of the disclosure, the convergence timing of the AI model can be determined according to the predicted lane line states and/or the predicted context information of multiple pixels in the image area covered by the lane lines, and the corresponding labeled lane line states and/or the labeled context information, so as to accurately determine the convergence timing of the AI model and effectively reduce the consumption of computing resources for the model training, thereby ensuring the detection and recognition effect of the trained lane line detection model.

In S205, a plurality of first loss values between a plurality of predicted lane line states and a corresponding plurality of labeled lane line states are determined.

After determining the plurality of predicted lane line states and the corresponding plurality of labeled lane line states, the loss values between each predicted lane line state and the corresponding labeled lane line state can be determined as the first loss values, which can be used to represent the loss difference of the lane line detection model for predicting the lane line state.

In S206, a target first loss value is selected from the plurality of first loss values, and target predicted lane line information and target labeled lane line information corresponding to the target first loss value are determined.

In some embodiments, a first loss value greater than a preset loss threshold value may be selected from the plurality of first loss values as the target first loss value. That is, when the first loss value is greater than the preset loss threshold value, it indicates that the predicted lane line state is more closer to the labeled lane line state, and it reflects that the model at this time has more accurate state recognition results, thereby making the determination of the loss value more in line with the detection logic of an actual model, and ensuring the practicality and rationality of the method.

If the preset loss threshold value is set to 0.5, for example, when the first loss value is greater than 0.5, it can indicate that the detection accuracy of the lane line detection model for the lane line state at this stage satisfies certain requirements, and the predicted detection results for the lane line type or other lane line information can be determined.

The first loss value satisfying certain conditions selected from the plurality of first loss values can be called the first target loss value. The predicted lane line information corresponding to the predicted lane line state which corresponds to the first target loss value can be called the target predicted lane line information, and the labeled lane line information corresponding to the labeled lane line state which corresponds to the first target loss value can be called the target labeled lane line information.

In S207, predicted context information in the target predicted lane line information, and labeled context information in the target labeled lane line information are determined.

After determining the target predicted lane line information and the target labeled lane line information corresponding to the target first loss value, the predicted context information in the target predicted lane line information, and the labeled context information in the target labeled lane line information can be determined, and then subsequent steps can be triggered.

In S208, a second loss value between the predicted context information and the target labeled lane line information is determined as the target loss value.

For example, the loss function can be configured to improve the structure of the HRNet-OCR model. The loss function can be used to fit the difference between the predicted context information and the target labeled lane line information, and the second loss value obtained is taken as the above target loss value, which is not limited.

That is, in the embodiment of the disclosure, the convergence timing of the AI model is determined based on loss values in multiple dimensions. When the first loss values determined based on the lane line states satisfy certain conditions, it is triggered to determine the corresponding second loss value based on the predicted context information and the target labeled lane line information as the target loss value, to determine the convergence timing.

Therefore, the accuracy of fitting loss values can be effectively improved, and when the convergence timing of the model is determined based on the target loss value, the lane detection model can obtain more accurate detection and recognition results.

For example, a branch structure can be added to the network structure of the HRNet-OCR model to detect and segment the lane lines. The preset number of lane lines is 4, and thus 4 is added to the element type as the total type output by the HRNet-OCR model. The above loss of element segmentation is l_{seg_ele}, the loss of the lane line detection and recognition may be added, which includes two portions, the pixel loss l_{seg_lane} and the binary-classification loss lₑₓᵢₛₜ depending on the existence of 4 lane lines. If the i^{th} lane line exists, then gtₑₓᵢₛₜⁱ=1, otherwise gtₑₓᵢₛₜⁱ=0. Correspondingly, the total loss value output by the HRNet-OCR model can be expressed as:

lₜₒₜₐₗ=l_{seg_ele}+l_{seg_lane}+0.1*lₑₓᵢₛₜ.

In the lane line detection and recognition stage, if preₑₓᵢₛₜⁱ>0.5, it indicates that the state of the i^{th} lane line is that the i^{th} lane line exists, so the predicted pixel result (including predicted context information, and lane line prediction type) is output; otherwise, it indicates that the lane line does not exist.

In the embodiment of the disclosure, an effective segmentation network structure fusing the element semantics and the lane line recognition is realized for road condition images, to improve the accuracy of element semantics and lane line instance segmentation, so as to provide reliable lane line segmentation results for smart traffic and smart city systems.

In S209, the AI model trained is determined as the lane line detection model, in response to a target loss value between the plurality pieces of predicted lane line information and the plurality pieces of labeled lane line information satisfying preset conditions.

The description of S209 can be specifically referred to the above embodiments, and will not be repeated here.

In the embodiment of the disclosure, the road condition sample images and the plurality pieces of labeled lane line information corresponding to the road condition sample images are obtained. The elements corresponding to the road condition sample images respectively and the element semantics corresponding to the elements respectively are determined. The initial AI model is trained according to the road condition sample images, the elements, the element semantics and the plurality pieces of labeled lane line information to obtain the lane line detection model. Therefore, the computing complexity of lane line detection and recognition in the road condition images can be reduced, the efficiency of lane detection and recognition is enhanced, and the effect of lane detection and recognition is improved. Since the target elements are identified at first, and then the target elements, the target element semantics corresponding to the target elements, and the road condition sample images are input into the lane line detection sub-model to obtain the predicted lane line information output by the lane line detection sub-model. Therefore, the pertinence of a model processing and recognition is improved, the interference from other elements on lane line detection can be avoided, and the accuracy of detection and recognition is improved while facilitating and improving the detection and recognition efficiency of the lane line detection model. In the embodiment of the disclosure, the convergence timing of the AI model can be determined according to the above predicted lane line states and/or the predicted context information of multiple pixels in the image area covered by the lane lines, and the corresponding labeled lane line states and/or the labeled context information, so as to accurately determine the convergence timing of the AI model and effectively reduce the consumption of computing resources for model training, thereby ensuring the detection and recognition effect of the trained lane line detection model.

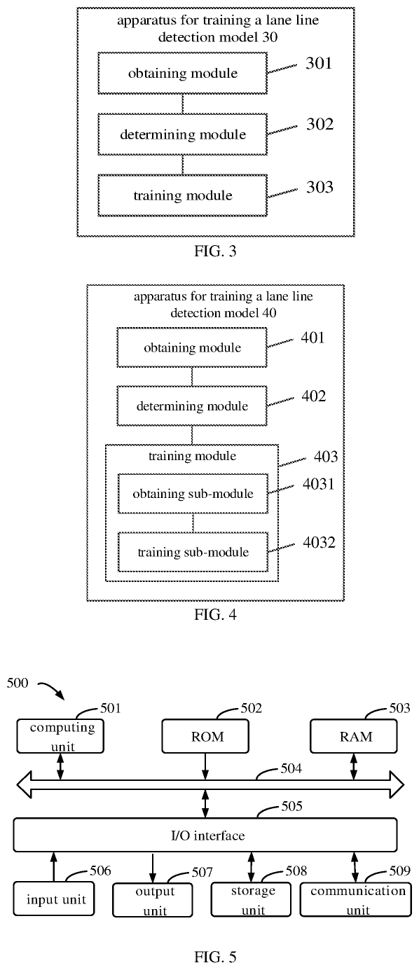

FIG. 3 is a schematic diagram of a third embodiment of the disclosure.

As illustrated in FIG. 3, the apparatus for training a lane line detection model 30 includes: an obtaining module 301, a determining module 302 and a training module 303.

The obtaining module 301 is configured to obtain a plurality of road condition sample images and a plurality pieces of labeled lane line information corresponding to the plurality of road condition sample images.

The determining module 302 is configured to determine a plurality of elements corresponding to the plurality of road condition sample images and a plurality of element semantics corresponding to the plurality of elements.

The training module 303 is configured to obtain the lane line detection model by training an initial AI model based on the plurality of road condition sample images, the plurality of elements, the plurality of element semantics and the plurality pieces of labeled lane line information.

In some embodiments of the disclosure, as illustrated in FIG. 4, FIG. 4 is a schematic diagram of a fourth embodiment of the disclosure. The apparatus for training a lane line detection model 40 includes: an obtaining module 401, a determining module 402 and a training module 403.

The training module 403 includes: an obtaining sub-module 4031 and a training sub-module 4032.

The obtaining sub-module 4031 is configured to input the plurality of road condition sample images, the plurality of elements and the plurality of element semantics into the initial AI model, to obtain a plurality pieces of predicted lane line information output by the AI model.

The training sub-module 4032 is configured to determine the initial AI model trained as the lane line detection model, in response to a target loss value between the plurality pieces of predicted lane line information and the plurality pieces of labeled lane line information satisfying preset conditions.

In some embodiments of the disclosure, the lane line information includes: lane line state and/or context information of a plurality of pixels in an image area covered by a lane line, and the image area is a local image area containing the lane line in the road condition sample image.

In some embodiments of the disclosure, the training sub-module 4032 is further configured to:

determine a plurality of first loss values between a plurality of predicted lane line states and a plurality of labeled lane line states;

select a target first loss value from the plurality of first loss values, and determine target predicted lane line information and labeled target lane line information corresponding to the target first loss value;

determine predicted context information in the target predicted lane line information, and determine labeled context information in the labeled target lane line information; and

determine a second loss value between the predicted context information and the labeled target lane line information, as the target loss value.

In some embodiments of the disclosure, the training sub-module 4032 is further configured to:

determine a first loss value greater than a preset loss threshold value from the plurality of first loss values as the target first loss value.

In some embodiments of the disclosure, the initial AI model includes an element detection sub-model and a lane line detection sub-model sequentially connected. The obtaining sub-module 4031 is further configured to:

input the plurality of road condition sample images, the plurality of elements and the plurality of element semantics into the element detection sub-model, to obtain target elements output by the element detection sub-model; and

input the target elements, target element semantics corresponding to the target elements, and the plurality of road condition sample images into the lane line detection sub-model, to obtain the plurality pieces of predicted lane line information output by the lane line detection sub-model.

It can be understood that the apparatus 40 in FIG. 4 of the embodiment of the disclosure and the apparatus 30 in the above embodiments, the obtaining module 401 and the obtaining module 301, the determining module 402 and the determining module 302, and the training module 403 and the training module 303 in the above embodiments can have the same function and structure.

It should be noted that the foregoing explanation of the method for training a lane line detection model is also applicable to the apparatus for training a lane line detection model of the embodiment of the disclosure, which will not be repeated here.

In the embodiment of the disclosure, the plurality of road condition sample images and the plurality pieces of the lane line information corresponding to the plurality of road condition sample images are obtained. The plurality of elements corresponding to the plurality of road condition sample images and the plurality of element semantics corresponding to the plurality of elements are determined. The lane line detection model is obtained by training the initial AI model based on the plurality of road condition sample images, the plurality of elements, the plurality of element semantics and the plurality pieces of labeled lane line information. In this way, the computing complexity for detecting and recognizing lane lines in the road condition images is effectively reduced, the efficiency of detecting and recognizing lane lines is improved, and the effect of detecting and recognizing lane lines can be improved.

According to the embodiments of the disclosure, the disclosure also provides an electronic device, a readable storage medium and a computer program product.

FIG. 5 is a block diagram of an electronic device for implementing the method for training a lane line detection model according to the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 5, the device 500 includes a computing unit 501 performing various appropriate actions and processes based on computer programs stored in a read-only memory (ROM) 502 or computer programs loaded from the storage unit 508 to a random access memory (RAM) 503. In the RAM 503, various programs and data required for the operation of the device 500 are stored. The computing unit 501, the ROM 502, and the RAM 503 are connected to each other through a bus 504. An input/output (I/O) interface 505 is also connected to the bus 504.

Components in the device 500 are connected to the I/O interface 505, including: an inputting unit 506, such as a keyboard, a mouse; an outputting unit 507, such as various types of displays, speakers; a storage unit 508, such as a disk, an optical disk; and a communication unit 509, such as network cards, modems, and wireless communication transceivers. The communication unit 509 allows the device 500 to exchange information/data with other devices through a computer network such as the Internet and/or various telecommunication networks.

The computing unit 501 may be various general-purpose and/or dedicated processing components with processing and computing capabilities. Some examples of computing unit 501 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 501 executes the various methods and processes described above, such as the method for training a lane line detection model.

For example, in some embodiments, the method for training a lane line detection model may be implemented as a computer software program, which is tangibly contained in a machine-readable medium, such as the storage unit 508. In some embodiments, part or all of the computer program may be loaded and/or installed on the device 500 via the ROM 502 and/or the communication unit 509. When the computer program is loaded on the RAM 503 and executed by the computing unit 501, one or more steps of the method described above may be executed. Alternatively, in other embodiments, the computing unit 501 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve the defects of difficult management and weak business scalability in the traditional physical host and virtual private server (VPS) service. The server can also be a server of distributed system or a server combined with block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

1. A method for training a lane line detection model, comprising:
obtaining a plurality of road condition sample images and a plurality pieces of labeled lane line information corresponding to the plurality of road condition sample images;
determining a plurality of elements corresponding to the plurality of road condition sample images and a plurality of element semantics corresponding to the plurality of elements; and
obtaining the lane line detection model by training an initial artificial intelligence (AI) model based on the plurality of road condition sample images, the plurality of elements, the plurality of element semantics and the plurality pieces of labeled lane line information.

2. The method of claim 1, wherein obtaining the lane line detection model by training the initial AI model based on the plurality of road condition sample images, the plurality of elements, the plurality of element semantics and the plurality pieces of labeled lane line information, comprises:
inputting the plurality of road condition sample images, the plurality of elements and the plurality of element semantics into the initial AI model, to obtain a plurality pieces of predicted lane line information output by the initial AI model; and
determining the initial AI model trained as the lane line detection model, in response to a target loss value between the plurality pieces of predicted lane line information and the plurality pieces of labeled lane line information satisfying preset conditions.

3. The method of claim 2, wherein the labeled lane line information comprises: at least one of a lane line state or context information of a plurality of pixels in an image area covered by a lane line, and the image area is a local image area containing the lane line in the road condition sample image.

4. The method of claim 3, wherein determining the target loss value between the plurality pieces of predicted lane line information and the plurality pieces of labeled lane line information comprises:
determining a plurality of first loss values between a plurality of predicted lane line states and a plurality of labeled lane line states;
selecting a target first loss value from the plurality of first loss values, and determining target predicted lane line information and target labeled lane line information corresponding to the target first loss value;
determining predicted context information in the target predicted lane line information, and determining labeled context information in the target labeled lane line information; and
determining a second loss value between the predicted context information and the target labeled lane line information, as the target loss value.

5. The method of claim 4, wherein selecting the target first loss value from the plurality of first loss values comprises:
determining a first loss value greater than a preset loss threshold value from the plurality of first loss values as the target first loss value.

6. The method of claim 2, the initial AI model comprises an element detection sub-model and a lane line detection sub-model sequentially connected, wherein,
inputting the plurality of road condition sample images, the plurality of elements and the plurality of element semantics into the initial AI model, to obtain the plurality pieces of predicted lane line information output by the AI model, comprises:
inputting the plurality of road condition sample images, the plurality of elements and the plurality of element semantics into the element detection sub-model, to obtain target elements output by the element detection sub-model; and
inputting the target elements, target element semantics corresponding to the target elements, and the plurality of road condition sample images into the lane line detection sub-model, to obtain the plurality pieces of predicted lane line information output by the lane line detection sub-model.

7-12. (canceled)

13. An electronic device, comprising:
at least one processor; and
a memory communicatively coupled to the at least one processor; wherein,
the memory stores instructions executable by the at least one processor, when the instructions are executed by the at least one processor, the at least one processor is configured to:
obtain a plurality of road condition sample images and a plurality pieces of labeled lane line information corresponding to the plurality of road condition sample images;
determine a plurality of elements corresponding to the plurality of road condition sample images and a plurality of element semantics corresponding to the plurality of elements; and
obtain the lane line detection model by training an initial artificial intelligence (AI) model based on the plurality of road condition sample images, the plurality of elements, the plurality of element semantics and the plurality pieces of labeled lane line information.

14. A non-transitory computer-readable storage medium having computer instructions stored thereon, wherein the computer instructions are configured to cause a computer to execute a method for training a lane line detection model comprising:
obtaining a plurality of road condition sample images and a plurality pieces of labeled lane line information corresponding to the plurality of road condition sample images;
determining a plurality of elements corresponding to the plurality of road condition sample images and a plurality of element semantics corresponding to the plurality of elements; and
obtaining the lane line detection model by training an initial artificial intelligence (AI) model based on the plurality of road condition sample images, the plurality of elements, the plurality of element semantics and the plurality pieces of labeled lane line information.

15. (canceled)

16. The electronic device of claim 13, wherein the at least one processor is configured to:
input the plurality of road condition sample images, the plurality of elements and the plurality of element semantics into the initial AI model, to obtain a plurality pieces of predicted lane line information output by the initial AI model; and
determine the initial AI model trained as the lane line detection model, in response to a target loss value between the plurality pieces of predicted lane line information and the plurality pieces of labeled lane line information satisfying preset conditions.

17. The electronic device of claim 16, wherein the labeled lane line information comprises: at least one of a lane line state or context information of a plurality of pixels in an image area covered by a lane line, and the image area is a local image area containing the lane line in the road condition sample image.

18. The electronic device of claim 17, wherein the at least one processor is configured to:
determine a plurality of first loss values between a plurality of predicted lane line states and a plurality of labeled lane line states;
select a target first loss value from the plurality of first loss values, and determine target predicted lane line information and target labeled lane line information corresponding to the target first loss value;
determine predicted context information in the target predicted lane line information, and determine labeled context information in the target labeled lane line information; and
determine a second loss value between the predicted context information and the target labeled lane line information, as the target loss value.

19. The electronic device of claim 18, wherein the at least one processor is configured to:
determine a first loss value greater than a preset loss threshold value from the plurality of first loss values as the target first loss value.

20. The electronic device of claim 16, wherein the initial AI model comprises an element detection sub-model and a lane line detection sub-model sequentially connected, and the at least one processor is configured to:
input the plurality of road condition sample images, the plurality of elements and the plurality of element semantics into the element detection sub-model, to obtain target elements output by the element detection sub-model; and
input the target elements, target element semantics corresponding to the target elements, and the plurality of road condition sample images into the lane line detection sub-model, to obtain the plurality pieces of predicted lane line information output by the lane line detection sub-model.

21. The non-transitory computer-readable storage medium of claim 14, wherein obtaining the lane line detection model by training the initial AI model based on the plurality of road condition sample images, the plurality of elements, the plurality of element semantics and the plurality pieces of labeled lane line information, comprises:
inputting the plurality of road condition sample images, the plurality of elements and the plurality of element semantics into the initial AI model, to obtain a plurality pieces of predicted lane line information output by the initial AI model; and
determining the initial AI model trained as the lane line detection model, in response to a target loss value between the plurality pieces of predicted lane line information and the plurality pieces of labeled lane line information satisfying preset conditions.

22. The non-transitory computer-readable storage medium of claim 21, wherein the labeled lane line information comprises: at least one of a lane line state or context information of a plurality of pixels in an image area covered by a lane line, and the image area is a local image area containing the lane line in the road condition sample image.

23. The non-transitory computer-readable storage medium of claim 22, wherein determining the target loss value between the plurality pieces of predicted lane line information and the plurality pieces of labeled lane line information comprises:
determining a plurality of first loss values between a plurality of predicted lane line states and a plurality of labeled lane line states;
selecting a target first loss value from the plurality of first loss values, and determining target predicted lane line information and target labeled lane line information corresponding to the target first loss value;
determining predicted context information in the target predicted lane line information, and determining labeled context information in the target labeled lane line information; and
determining a second loss value between the predicted context information and the target labeled lane line information, as the target loss value.

24. The non-transitory computer-readable storage medium of claim 23, wherein selecting the target first loss value from the plurality of first loss values comprises:
determining a first loss value greater than a preset loss threshold value from the plurality of first loss values as the target first loss value.

25. The non-transitory computer-readable storage medium of claim 8, the initial AI model comprises an element detection sub-model and a lane line detection sub-model sequentially connected, wherein inputting the plurality of road condition sample images, the plurality of elements and the plurality of element semantics into the initial AI model, to obtain the plurality pieces of predicted lane line information output by the AI model, comprises:
inputting the plurality of road condition sample images, the plurality of elements and the plurality of element semantics into the element detection sub-model, to obtain target elements output by the element detection sub-model; and
inputting the target elements, target element semantics corresponding to the target elements, and the plurality of road condition sample images into the lane line detection sub-model, to obtain the plurality pieces of predicted lane line information output by the lane line detection sub-model.
